(19) United States
(12) Patent Application Publication
(10) Pub. No.: US 2009/0010420 A1
(43) Pub. Date: Jan. 8, 2009

(54) Method of managing queue at the service provider end

(76) Inventor: Sunil Khanna, Singapore (SG)

Correspondence Address: FROMMER LAWRENCE & HAUG, 745 FIFTH AVENUE- 10TH FL., NEW YORK, NY, 10151, US

(21) Appl. No.: 11/824,617

(22) Filed: Jul. 2, 2007

(51) Int. Cl. G06F 17/00

(52) U.S. Cl. 379/266.01

(57) ABSTRACT

The present invention relates to a method for assisting in reducing the queue length in public and private waiting areas such as government organizations or quasi government organizations or private sector organizations or individuals or group of individuals wherein the method is based on the concept of providing to the customer data which would enable him to take decision that would either reduce the queue length at the service provider's end and/or reduce his waiting time and/or reduce the customer service cost and/or enhance the customer satisfaction.

### FIELD OF THE INVENTION

The present invention relates to a reliable method for managing queue at service provider end such that the customer does not have to wait in queue for uncertain amount of time period for availing the service provided by the service provider. It is believed that the method of the present invention would assist in reducing the queue length in public and private waiting areas.

### BACKGROUND OF THE INVENTION

At present, we come across situations where customers are required to wait in a queue in order to be served at a service counter. We are well aware of the queues that come across in our daily lives i.e. at the government offices providing services to the public (town hall services, transport system, immigration, etc.) and in the private sectors (doctors, hospitals, telecommunication services, banking services, travel services, restaurants, etc.). In addition to physical queues, telephone queue also has come into picture after the advent of the call centre wherein a customer is required to wait in a telephone queue for availing the service being provided by the call centre.

Whether the queue is a physical queue or a telephone queue, waiting in the queue can be a frustrating experience in today's fast moving world. The frustration arises because the customer does not know how much longer he or she has to wait in the queue before being served, when is the best time to join the queue and hence a lot of time is wasted since he cannot leave his place in the queue.

Several prior art solutions have been offered to address these problems. There are certain electronic queue based systems that enable the organization's customer service personnel to better manage the queue. When a customer enters the service area, they must first obtain a ticket number as a way of identifying themselves. When one of the customer service personnel becomes free, he or she presses a button and the system displays the next queue number. When the customer's identification number is displayed, he or she knows that it is their turn to be served.

The main drawback of this system is that the customer still has to be physically at the location to obtain a queuing ticket, and must remain in the physical vicinity in order to keep an eye on the electronic display.

In the case of telephone queuing, like the telephone call centers, various diversionary tactics are employed to encourage the customer to remain on line. However, the above mentioned method is not very successful in mitigating the frustration of the caller.

Thus there exists a need to provide an improved method for managing queue at service provider end such that the customer does not have to wait in queue for uncertain amount of time period for availing the service provided by the service provider. Another aspect is to provide an improved method for managing queue at the service provider end such that the waiting time of the customer is reduced, thereby reducing the customer service cost and enhancing the customer satisfaction.

### SUMMARY OF THE INVENTION

Accordingly, the present invention relates to a method for assisting in reducing the queue length in public and private waiting areas which method is based on the concept of providing to the customer data which would enable him to take decision that would either reduce the queue length at the service provider's end and/or reduce his waiting time and/or reduce the customer service cost and/or enhance the customer satisfaction.

Accordingly, the present invention provides a method of managing queue at service provider end, said method comprising the steps of:

receiving a request for registration in respect of one or more services from a customer;
allocating a unique identification number to the request for registration and placing the request in a queue;
calculating a first estimated appointment time;
communicating the first estimated appointment time and the unique identification number to the customer.

In an embodiment of the present invention, the service provider is:

(a) a call centre service provider; or
(b) a direct service provider.

In another embodiment of the present invention, the call centre service provider is a service provider where a phone queue is encountered.

In yet another embodiment of the present invention, the call centre service provider is a call-back call centre.

In one more embodiment of the present invention, the direct service provider includes government organizations or quasi government organizations or private sector organizations or individuals or group of individuals providing service.

In a further embodiment of the present invention, the direct service provider includes service providers where a physical queue is encountered.

In a further more embodiment of the present invention, the request for registration is in the form of a telephone call or a sms or via an e-mail or a registration at a designated web site or a feed back from a person or a written correspondence or a request received by an automatic voice response (AVR) system, if the service provider is a call-back call centre.

In an embodiment of the present invention, the request for registration is in the form of a request which is received at a registration terminal or via a telephone call or via a sms or via an e-mail or a registration at a designated web site or a feed back from a person or a written correspondence or a request received by an automatic voice response (AVR) system or verbal correspondence with a designated person, if the service provider is a direct service provider.

In another embodiment of the present invention, the registration terminal is selected from the group comprising a kiosk or a processing terminal.

In yet another embodiment of the present invention, the request for registration comprises:

a. an identification of the customer requesting the registration;
b. name of the customer;
c. telephone number on which the call centre personal must call;
d. an alternate telephone number;
e. an identification of the service being requested;
f. a mobile number;
g. an e-mail id; and
h. preferred time period for the appointment.

In still another embodiment of the present invention, the first estimated appointment time and the unique identification number is communicated to the customer via a telephone call, if the service provider is a call centre.

In one more embodiments of the present invention, the first estimated appointment time and the unique identification number is communicated to the customer through sms, if the service provider is a call centre.

In one another embodiment of the present invention, the first estimated appointment time and the unique identification number is communicated to the customer through an e-mail or through a registered web-site, if the service provider is a call centre.

In a further embodiment of the present invention, the first estimated appointment time and the unique identification number is displayed to the customer on the registration terminal at the time of registration, if the service provider is a direct service provider.

In a further more embodiment of the present invention, a ticket is generated indicating the first estimated appointment time and the unique identification number at the registration terminal at the time of registration, if the service provider is a direct service provider.

In an embodiment of the present invention, the first estimated appointment time and the unique identification number is communicated to the customer through an e-mail or through a registered web-site upon registration, if the service provider is a direct service provider.

In another embodiment of the present invention, the first estimated appointment time and the unique identification number is sent to the customer via a sms upon registration, if the service provider is a direct service provider.

In yet another embodiment of the present invention, the first estimated appointment time and the unique identification number are communicated to the customer via telephone upon registration, if the service provider is a direct service provider.

In still another embodiment, the method of the present invention further comprises calculating a first estimated waiting time.

In one more embodiment, the method of the present invention further comprises communicating the first estimated waiting time and the unique identification number to the customer.

In one another embodiment of the present invention, the first estimated waiting time is communicated to the customer via telephone, a predetermined time period prior to the first estimated appointment time.

In a further embodiment of the present invention, the first estimated waiting time is communicated to the customer via a sms, a predetermined time period prior to the first estimated appointment time.

In a further more embodiment of the present invention, the first estimated waiting time is communicated to the customer through an e-mail, a predetermined time period prior to the first estimated appointment time.

In an embodiment of the present invention, the first estimated waiting time is displayed on a display device, a predetermined time period prior to the first estimated appointment time.

In another embodiment of the present invention, the predetermined amount of time period is greater than or equal to the first estimated waiting time.

In yet another embodiment, the method of the present invention optionally or in other words further comprises receiving a request for amending the first estimated appointment time.

In still embodiment of the present invention, the request for amending the first estimated appointment time is receivable a second predetermined amount of time period prior to the said first estimated appointment time.

In one more embodiment of the present invention, the request for amending the first estimated appointment time is receivable via a telephone call or a sms or via an e-mail or a registration at a designated web site or a feed back from a person or a written correspondence or a request received by an automatic voice response (AVR) system, if the service provider is a call-back call centre.

In one another embodiment of the present invention, the request for amending the first estimated appointment time is receivable via a registration terminal or via a telephone call or via a sms or via an e-mail or a registration at a designated web site or a feed back from a person or a written correspondence or a request received by an automatic voice response (AVR) system or verbal correspondence with a designated person, if the service provider is a direct service provider.

In a further embodiment of the present invention, the request for amending the first estimated appointment time is optionally accompanied by a preferred time period for the appointment.

In a further more embodiment, the method of the present invention further comprises calculating a second estimated appointment time and communicating the same to the consumer.

In an embodiment, the method of the present invention further comprises calculating a second estimated waiting time and communicating the same to the consumer.

In another embodiment, the method of the present invention further comprises receiving a request for appointment from the customer prior to the receipt of the request for registration.

In yet another embodiment of the present invention, the request for appointment is received in the form of a telephone call or a sms or an e-mail or a registration on a designated web-site or a written correspondence or a verbal correspondence with a designated person.

In still another embodiment of the present invention, in response to the receipt of the request for appointment a time period for registration is communicated to the customer.

In one more embodiment of the present invention, the total number of requests for registration received over a third predetermined amount of time period is displayed on a designated web-site.

In one another embodiment of the present invention, the communication of the first estimated appointment time and the unique identification number to the customer is accompanied by advertisement material.

In a further embodiment of the present invention, the communication of the first estimated waiting time and the unique identification number to the customer is accompanied by advertisement material.

In a further more embodiment of the present invention, the communication of the second estimated appointment time to the customer is accompanied by advertisement material.

In an embodiment of the present invention, the communication of the second estimated waiting time to the customer is accompanied by advertisement material.

In another embodiment of the present invention, the communication of the time period for registration to the customer is accompanied by advertisement material.

### BRIEF DESCRIPTION OF THE DRAWINGS

In order that the invention may be readily understood and put into practical effect, reference will now be made to exemplary embodiments as illustrated with reference to the accompanying drawings, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 illustrates the schematic representation of method for managing queue in accordance with an embodiment of the present invention.

FIG. 2 illustrates the schematic representation of the method for managing queue in accordance with another embodiment of the present invention.

The following paragraphs are provided in order to describe the working of the invention and nothing in this section should be taken as a limitation of the claims.

### DETAILED DESCRIPTION OF THE INVENTION

Before describing in detail embodiments that are in accordance with the present invention, it should be observed that the embodiments reside primarily in combinations of method steps of managing queue at service provider end such that the customer does not have to wait in queue for uncertain amount of time period for availing the service provided by the service provider.

Accordingly, the method steps have been represented where appropriate by conventional symbols in the drawings, showing only those specific details that are pertinent to understanding the embodiments of the present invention so as not to obscure the disclosure with details that will be readily apparent to those of ordinary skill in the art having benefit of the description herein.

The terms “comprises”, “comprising”, or any other variations thereof, are intended to cover a non-exclusive inclusion, such that a process, method that comprises a list of steps does not include only those steps but may include other steps not expressly listed or inherent to such process, method. An element proceeded by “comprises . . . a” does not, without more constraints, preclude the existence of additional identical steps in the process or method that comprises the steps.

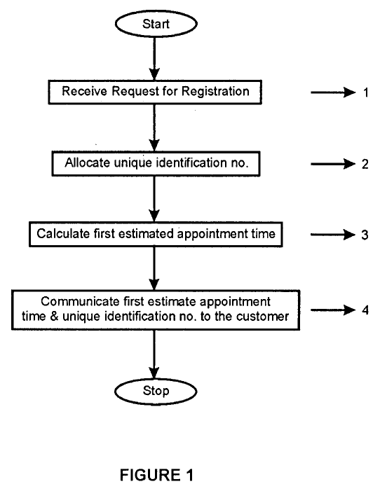

As described in the preceding paragraphs and as illustrated in FIG. 1, the method of managing queue at service provider end comprises the steps of: receiving a request for registration in respect of one or more services from a customer (1); allocating a unique identification number to the request for registration and placing the request in a queue (2); calculating a first estimated appointment time (3); and communicating the first estimated appointment time and the unique identification number to the customer (4).

Depending upon the nature of the service provider, the above mentioned steps can be implemented in different ways. Thus, prior to describing the steps per se, a brief description of the service provider is provided. However, it should be understood that the method of the present invention is not limited to only the service providers specifically identified here below and has more wide applications.

By way of example, the service providers are broadly classified into two categories, namely a call centre service provider and a direct service provider. The call centre service provider includes the service providers where typically a telephone queue is encountered while the direct service provider includes the service providers where a physical queue is encountered.

By way of example, the direct service provider includes government organizations or quasi government organizations or private sector organizations or individuals or group of individuals providing service. Purely by way of example, the private sector organizations includes ticket counter or reservation counter of a particular airline company which is encountered at the airport, various counters encountered at banks, hospitals, hotels, etc. Similarly, the individual direct service providers may by way of example include doctors, lawyers, or any other professional. The group of individuals may include restaurant, cafeteria, partnership firms, etc.

Now if we consider the service provider to be a call centre, the request for registration can be received in a number of ways. Some of the manners in which the call centre personal can receive the request for registration include:

(a) receipt of request for registration via a telephone call;
(b) receipt of request for registration via a sms;
(c) receipt of request for registration via an e-mail;
(d) receipt of request for registration via a registration at a designated web site;
(e) receipt of request for registration from a person in the form of feed back;
(f) receipt of request for registration via a written correspondence; and
(g) receipt of request for registration via an automatic voice response (AVR) system.

In the first scenario, when the service provider and the request for registration is received via a telephone call, it is not mandatory that the call should be answered by a call centre person. In an embodiment, if the call centre has a call identification facility, registration of the calling number in itself can be taken as a request for registration.

In the second scenario, when the request for registration is received via a sms, the number to which the sms is transmitted may be the number of an intermediary. Alternatively, the sms can be sent to a number which is directly controlled for the time being by the call centre service provider.

The request for registration can be sent by the customer via an e-mail, wherein the e-mail of the service provider is monitored by a call centre personal. Alternatively, the request for registration can be sent via a registration on a designated web-site, wherein the designated web-site may be the web-site of the call centre service provider.

In another embodiment, the request for registration can be received in the form of a request which is communicated to a person. By way of example, a customer or a prospective customer may indicate to a service personal that he would be interested in knowing about the company's latest range of products. The above message may be passed on by the service personal to the call centre in the form of a request for registration.

In yet another scenario, the request for registration can be received from the customer in the form of a written correspondence, such as a written correspondence is sent through the conventional post or deposited at a designated terminal. In still another scenario, the request for registration can be received via an automatic voice response system.

Now if we consider the service provider to be a direct service provider, the request for registration can be received in a number of ways. Some of the manners in which the direct service provider or a personal at the direct service provider can receive the request for registration include:

(a) receipt of request for registration at a registration terminal;
(b) receipt of request for registration via a telephone call;
(c) receipt of request for registration via a sms;
(d) receipt of request for registration via an e-mail;
(e) receipt of request for registration in the form of registration at a designated web site;
(f) receipt of request for registration from a person in the form of feed back;
(g) receipt of request for registration via a written correspondence;
(h) receipt of request for registration via an automatic voice response (AVR) system; and
(i) receipt of request for registration in the form of a verbal correspondence.

Similar to the call centre scenario, even in the case of a direct service provider, the request for registration can be received via a telephone call, wherein it is not mandatory that the call should be answered by a person. The request for registration can be received via a sms, the number to which the sms is transmitted may be the number of an intermediary. Alternatively, the sms can be sent to a number which is directly controlled for the time being by the direct service provider. By way of example, if the direct service provider is an individual or a group of individuals, the sms can be sent to the number which belongs to the individual or to any one from the group of individuals.

The request for registration can be sent by the customer via an e-mail, wherein the e-mail is that of the direct service provider. Alternatively, the request for registration can be sent via a registration on a designated web-site, wherein the designated web-site may be the web-site of the direct service provider.

In another embodiment, the request for registration can be received in the form of a request which is communicated to a person. By way of example, a customer or a prospective customer may indicate to a service personal or to a person whom the direct service provides knows that he would be interested in knowing about the services being offered by the direct service provider. The above message may be passed on by the person to the direct service provider in the form of a request for registration. In yet another scenario, the request for registration can be received from the customer in the form of a written correspondence. In still another scenario, the request for registration can be received via an automatic voice response system.

In addition to the above mentioned ways which are commonly available to both types of service providers, the direct service provider has some unique ways of receiving the request for registration.

Once of such unique ways of receiving the request for registration includes receiving the request via a registration terminal. The registration terminal may be located in close proximity of the service provider's premise/work place. The registration terminal may be in the form of a kiosk or in the form of a processing terminal. The kiosk includes a point of service counter and the processing terminal includes a computer terminal.

As it can be understood, in order to register, there should some basic information which is required to be provided by the customer. In order to avoid the customer from being burdened, it is envisaged that at least one of the following types of information would be requested from the customer at the time of registration. Although, in some cases, it may be necessary for the customer to provide more than one type of information in order to secure a registration. By way of example, any one of the following types of information can be provided by the customer at the time of registration or along with the request for registration:
an identification of the customer requesting the registration; or
name of the customer; or
telephone number on which the call centre personal must call; or
an alternate telephone number; or
an identification of the service being requested; or
a mobile number; or
an e-mail id; or
preferred time period for the appointment.

In some instances, it may be possible to obtain details of the customer on the basis of the identification of the customer. In such instances, it may be sufficient to merely obtain the identification of the customer.

According to a preferred aspect of the present invention, once the request for registration is received from a customer, the said request is allocated a unique identification number and is stored in an electronic queue. The electronic queue may be maintained an electronic device on the basis of any of the queuing techniques such as (a) first-in first out, (b) first-in last-out etc.

It can be said that allocation of the unique identification number and placement of the request for registration in the electronic queue is immediately effected after receipt of the request. This ensures that no request for registration is lost.

After the request for registration is allocated the unique identification number and is placed in the electronic queue, a controller calculates the first estimated appointment time.

As indicated above, in some instances, it may be possible to obtain an indication of the preferred time period for the appointment from the customer. Although it is preferred to calculate the first estimated appointment time with a view to keep it as close as possible to the preferred time period for the appointment indicated by the customer, it is not mandatory to do so. Also, it might be possible that despite taking into consideration the preferred time period for the appointment requested by the customer, the first estimated appointment time calculated may be substantially different from the preferred time period indicated by the customer.

The calculation of the first estimated appointment time can be based on one or more parameters. The parameters taken into consideration may depend upon the nature of the service being provided by the service provider. By way of example, the calculation of the first estimated appointment time may be on the basis of the number of customers already present in the queue, the approximate time that may take for each appointment, inter-appointment time required by the service provider (if any) and various other factors.

After the first estimated appointment time has been calculated, the same is communicated to the customer. In addition to communicating the first estimated time period for the appointment, in accordance with the method of the present invention, the unique identification number that was allocated to the customer immediately after receipt of his request for registration is communicated to the customer.

In accordance with a preferred aspect of the present invention, the communication of the first estimated appointment time and the unique identification number to the customer can be regarded as providing to the customer data which would enable him to take decision that would either reduce the queue length at the service provider's end and/or reduce his waiting time and/or reduce the customer service cost and/or enhance the customer satisfaction.

The first estimated appointment time and the unique identification number may be communicated to the customer in a number of ways. By way of example, if the service provider is a call centre, the first estimated appointment time and the unique identification number may be communicated to the customer in the following manners:
via a telephone call;
through a sms;
through an e-mail; and
through a registered web-site.

If the service provider is a direct service provider, in addition to the above described methods, the first estimated appointment time and the unique identification number may be communicated to the customer in the following manners:
displaying to the customer on the registration terminal at the time of registration;
generating a ticket containing the first estimated appointment time and the unique identification number at the registration terminal at the time of registration; and
verbally communicating the same at the time of registration.

It may happen that after receiving the first estimated appointment time and the unique identification number, the customer may decide to:
(i) withdraw his request for registration, this may happen if for example, the first estimated appointment time is inconvenient for him;
(ii) perform some other activity which does not require his personal presence in the service provider's premise, this may happen if the service provider is a direct service provider;
(iii) utilize the communication medium till the first estimated appointment time, this may happen in case of the service provider is a call centre;
(iv) or take any other action which suits his needs at that instance.

If the customer decides to withdraw his request for registration, this will result in reducing the queue length at the service provider's end. In the event the customer decides to choose any of the options mentioned in serial number (ii) or (iii), then it is anticipated that it will reduce the waiting time of the customer and/or reduce the customer service cost and/or enhance the customer satisfaction.

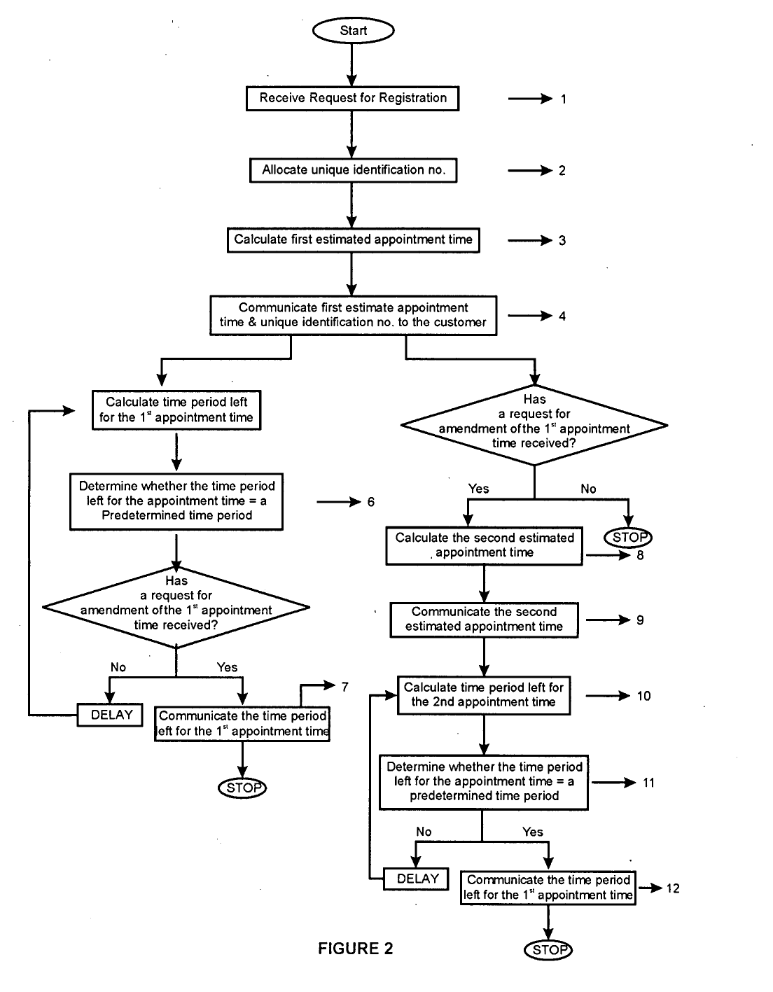

In order to encourage the customer to choose any of the options mentioned in serial number (ii) or (iii), as illustrated in FIG. 2, the method of the present invention may further comprise determining a time period left for the appointment, which is also referred to as “first estimated waiting time”. The time period left for the appointment is communicated to the customer. The communication of the time period left for the appointment may be accompanied by the unique identification number. If the customer has requested for more than one service from the same service provider, the nature of the service in respect of which the present communication is intended is also indicated. If the customer has requested for service from more than one service provider, the identification of the service provider who is sending the communication is also included in the communication.

Ideally, the first estimated waiting time (alternatively referred to as the time period left for the appointment) is communicated to the customer a predetermined time period prior to the first estimated appointment time, wherein the predetermined amount of time period may be greater than or equal to the first estimated waiting time. In some instances it may be advantageous to retain the predetermined amount of time period as marginally greater than the first estimated waiting time.

By way of example, the customer may be informed that the time period left for the appointment is 10 minutes. This communication may for example be sent about 12 minutes prior the estimated appointment time to compensate for any delay that can be incurred in the communication. By way of example, the delay in the communication can be caused due to heavy traffic at that instantaneous moment, or the communication device of the customer may be busy at that instantaneous moment.

The first estimated waiting time may be communicated to the customer via telephone or via a sms or through an e-mail or can be displayed on a display device.

In some instances, the customer after receiving the communication of the first estimated appointment time may be interested in the appointment, but may find the first estimated appointment time to be inconvenient. In such cases, instead of withdrawing his request for registration, he may send a request for amendment of the first estimated appointment time.

The request for amending the first estimated appointment time may be received under the two following conditions:
the customer immediately after receiving the communication of the first estimated appointment time may decide to send the request for amendment of the first estimated appointment time; or
the customer after expiry of certain amount of time period but prior to the first estimated appointment time may decide to send the request for amendment of the first estimated appointment time.

In some instances, there may be certain restrictions which may be imposed on the customer in respect of sending the request for amending the first estimated appointment time. By way of example, a restriction that the request for amendment must be received by the service provider a second predetermined amount of time period prior to the said first estimated appointment time can be imposed by the service provider. Alternatively or in addition to the above restriction, the service provider may impose some monetary restrictions on the customer.

The request for amending the first estimated appointment time can be received via a telephone call or a sms or via an e-mail or a registration at a designated web site or a feed back from a person or a written correspondence or a request received by an automatic voice response (AVR) system, if the service provider is a call-back call centre.

On the other hand, if the service provider is a direct service provider, the request for amending the first estimated appointment time can be received via the registration terminal or via a telephone call or via a sms or via an e-mail or a registration at a designated web site or a feed back from a person or a written correspondence or a request received by an automatic voice response (AVR) system or verbal correspondence with a designated person.

In certain instances, it may be advantageous to provide certain amount of grace period for the customer, if the customer is due to some reason delayed for the appointment. Such grace period can be provided inherently without the customer specifically requesting for the same. However, such grace period can be only for a short duration of time period.

In a preferred mode of operation, the customer may transmit a preferred time period for the appointment along with the request for amendment of the first estimated appointment time.

After receipt of the request for amendment, a controller calculates a second estimated appointment time. The second estimated appointment time can be calculated in a manner which is similar to the manner in which the first estimated appointment time is calculated. In case the customer has indicated a preferred time period for the appointment, the second estimated appointment time can be calculated in such a manner that it is as close as possible to the preferred time period for the appointment indicated by the customer. However, as mentioned earlier, it is not mandatory to do so and the second estimated appointment time calculated may be substantially different from the preferred time period indicated by the customer.

After the second estimated appointment time has been calculated, the same is communicated to the customer. The communication of the second estimated appointment time can be done in any of the ways in which the first estimated appointment time is communicated.

Similar to the step of determining the first estimated waiting time, the method of the present invention may further comprise determining a time period left for the second appointment, which is also referred to as “second estimated waiting time”. The time period left for the second appointment is communicated to the customer.

The second estimated waiting time (alternatively referred to as the time period left for the second appointment time) can be communicated to the customer in the same manner in which the first estimated waiting time is communicated. More particularly, the mode of communication and the time period of communication of the second estimated waiting time may be substantially the same as that for the first estimated waiting time.

In some instances, the customer may wish to seek appointment from the service provider. Such appointment may be sought by the customer prior to sending the request for registration. Such situations for example may be encountered in case of direct service providers and more particularly when the direct service provider is government or a quasi government organization.

By way of example, a customer may be interested in meeting the person who issues passport. It may happen that the issue of the passports is scheduled between 10:00 hrs and 12:00 hrs of every day. In many instances it is observed that the customer approaches the designated person outside the scheduled time period. In order to avoid such situation, the customer may seek prior appointment from the designated person. Such prior appointment can be sought prior to registration and such request for appointment may be received in the form of a telephone call or a sms or an e-mail or a registration on a designated web-site or a written correspondence or a verbal correspondence with the designated person. In case such a request for appointment is received and in response to such receipt, a time period for registration may be communicated to the customer.

In yet another aspect of the present invention, it may be advantageous to determine a total number of requests for registrations which are to be attended by the service provider within a third predetermined amount of time period and display them on a designated web-site. This may enable the customer to browse the designated web site and find out the total number of requests for registrations which are to be attended by the service provider. This information may be particularly useful in situations where the request for registration is received at the registration terminal. The customer in such situations may first browse through the designated web-site. It may also be possible to display on the web-site the expected time for appointment that would be granted for the next receivable request for registration.

In order to recover the cost of setting up the system and to generate additional revenue, all communications which are sent from the service provider may be accompanied by advertisement material. By way of example, the communication of the first estimated appointment time and the unique identification number to the customer is accompanied by advertisement material and/or the communication of the first estimated waiting time and the unique identification number to the customer is accompanied by advertisement material and/or the communication of the second estimated appointment time to the customer is accompanied by advertisement material and/or the communication of the second estimated waiting time to the customer is accompanied by advertisement material and/or the communication of the time period for registration to the customer is accompanied by advertisement material.

It will be appreciated that method steps of the invention described herein may be implemented using one or more conventional processors and unique stored program instructions that control the one or more processors to implement, in conjunction with certain non-processor circuits, some, most, or all of the functions described herein. Alternatively, some or all method steps could be implemented by a state machine that has no stored program instructions or in one or more application specific integrated circuits (ASICs), in which each method or some combinations of certain of the method steps are implemented as custom logic. Of course, a combination of the two approaches could be used. Thus, method and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The foregoing detailed description has described only a few of the many possible implementations of the present invention. Thus, the detailed description is given only by way of illustration and nothing contained in this section should be construed to limit the scope of the invention. The claims are limited only by the following claims, including the equivalents thereof.

We claim:

1. A method of managing queue at service provider end, said method comprising the steps of:
(a) receiving a request for registration in respect of one or more services from a customer;
(b) allocating a unique identification number to the request for registration and placing the request in an electronic queue;
(c) calculating a first estimated appointment time; and
(d) communicating the first estimated appointment time and the unique identification number to the customer.

2. The method as claimed in claim 1, wherein the service provider is a call centre service provider; or a direct service provider.

3. The method as claimed in claim 2, wherein the call centre service provider is a service provider where a phone queue is encountered.

4. The method as claimed in claim 2, wherein the call centre service provider is a call-back call centre.

5. The method as claimed in claim 2, wherein the direct service provider includes government organizations or quasi government organizations or private sector organizations or individuals or group of individuals providing service.

6. The method as claimed in claim 2, wherein the direct service provider includes service providers where a physical queue is encountered.

7. The method as claimed in claim 1, wherein the request for registration is in the form of a telephone call or a sms or via an e-mail or a registration at a designated web site or a feed back from a person or a written correspondence or a request received by an automatic voice response (AVR) system, if the service provider is a call-back call centre.

8. The method as claimed in claim 1, wherein the request for registration is in the form of a request which is received at a registration terminal or via a telephone call or via a sms or via an e-mail or a registration at a designated web site or a feed back from a person or a written correspondence or a request received by an automatic voice response (AVR) system or verbal correspondence with a designated person, if the service provider is a direct service provider.

9. The method as claimed in claim 8, wherein the registration terminal is selected from the group comprising a kiosk or a processing terminal.

10. The method as claimed in claim 1, wherein the request for registration comprises:
(a) an identification of the customer requesting the registration; or
(b) name of the customer; or
(c) telephone number on which the call centre personal must call; or
(d) an alternate telephone number; or
(e) an identification of the service being requested; or
(f) a mobile number; or
(g) an e-mail id; or
(h) preferred time period for the appointment.

11. The method as claimed in claim 1, wherein the first estimated appointment time and the unique identification number is communicated to the customer via a telephone call, if the service provider is a call centre.

12. The method as claimed in claim 1, wherein the first estimated appointment time and the unique identification number is communicated to the customer through sms, if the service provider is a call centre.

13. The method as claimed in claim 1, wherein the first estimated appointment time and the unique identification number is communicated to the customer through an e-mail or through a registered web-site, if the service provider is a call centre.

14. The method as claimed in claim 1, wherein the first estimated appointment time and the unique identification number is displayed to the customer on the registration terminal at the time of registration, if the service provider is a direct service provider.

15. The method as claimed in claim 1, wherein a ticket is generated indicating the first estimated appointment time and the unique identification number at the registration terminal at the time of registration, if the service provider is a direct service provider.

16. The method as claimed in claim 1, wherein the first estimated appointment time and the unique identification number is communicated to the customer through an e-mail or through a registered web-site upon registration, if the service provider is a direct service provider.

17. The method as claimed in claim 1, wherein the first estimated appointment time and the unique identification number is sent to the customer via a sms upon registration, if the service provider is a direct service provider.

18. The method as claimed in claim 1, wherein the first estimated appointment time and the unique identification number are communicated to the customer via telephone upon registration, if the service provider is a direct service provider.

19. The method as claimed in claim 1, further comprising calculating a first estimated waiting time.

20. The method as claimed in claim 19 further comprising communicating the first estimated waiting time and the unique identification number to the customer.

21. The method as claimed in claim 20, wherein the first estimated waiting time is communicated to the customer via telephone, a predetermined time period prior to the first estimated appointment time.

22. The method as claimed in claim 20, wherein the first estimated waiting time is communicated to the customer via a sms, a predetermined time period prior to the first estimated appointment time.

23. The method as claimed in claim 20, wherein the first estimated waiting time is communicated to the customer through an e-mail, a predetermined time period prior to the first estimated appointment time.

24. The method as claimed in claim 20, wherein the first estimated waiting time is displayed on a display device, a predetermined time period prior to the first estimated appointment time.

25. The method as claimed in claim 21, wherein the predetermined amount of time period is greater than or equal to the first estimated waiting time.

26. The method as claimed in claim 1 further comprising receiving a request for amending the first estimated appointment time.

27. The method as claimed in claim 26, wherein the request for amending the first estimated appointment time is receivable a second predetermined amount of time period prior to the said first estimated appointment time.

28. The method as claimed in claim 26, wherein the request for amending the first estimated appointment time is receivable via a telephone call or a sms or via an e-mail or a registration at a designated web site or a feed back from a person or a written correspondence or a request received by an automatic voice response (AVR) system, if the service provider is a call-back call centre.

29. The method as claimed in claim 26, wherein the request for amending the first estimated appointment time is receivable via a registration terminal or via a telephone call or via a sms or via an e-mail or a registration at a designated web site or a feed back from a person or a written correspondence or a request received by an automatic voice response (AVR) system or verbal correspondence with a designated person, if the service provider is a direct service provider.

30. The method as claimed in claim 26, wherein the request for amending the first estimated appointment time is accompanied by a preferred time period for the appointment.

31. The method as claimed in claim 26 further comprising calculating a second estimated appointment time and communicating the same to the consumer.

32. The method as claimed in claim 26 further comprising calculating a second estimated waiting time and communicating the same to the consumer.

33. The method as claimed in claim 1 further comprising receiving a request for appointment from the customer prior to the receipt of the request for registration.

34. The method as claimed in claim 33, wherein the request for appointment is received in the form of a telephone call or a sms or an e-mail or a registration on a designated web-site or a written correspondence or a verbal correspondence with a designated person.

35. The method as claimed in claim 33, wherein in response to the receipt of the request for appointment a time period for registration is communicated to the customer.

36. The method as claimed in claim 1, wherein the total number of requests for registration received over a third predetermined amount of time period is displayed on a designated web-site.

37. The method as claimed in claim 1, wherein the communication of the first estimated appointment time and the unique identification number to the customer is accompanied by advertisement material.

38. The method as claimed in claim 20, wherein the communication of the first estimated waiting time and the unique identification number to the customer is accompanied by advertisement material.

39. The method as claimed in claim 31, wherein the communication of the second estimated appointment time to the customer is accompanied by advertisement material.

40. The method as claimed in claim 32, wherein the communication of the second estimated appointment time to the customer is accompanied by advertisement material.

41. The method as claimed in claim 35, wherein the communication of the time period for registration to the customer is accompanied by advertisement material.
